(19) United States
(12) Patent Application Publication
(10) Pub. No.: US 2026/0350505 A1
(43) Pub. Date: Nov. 5, 2026

(54) ENTERPRISE RESOURCE PLANNING SYSTEM WITH SUPPORT FOR MULTIPLE DATABASE INTEGRATIONS

(71) Applicant: SAP SE, Walldorf (DE)

(72) Inventors: Michael Vollmer, Leimen (DE); Michael Witte, Dossenheim (DE); Gert Tackaert, Destelbergen (BE); Stefan Walz, Sinzheim (DE); Gabriele Hoffmann, Karlsruhe (DE); Shwetha H, Bangalore (IN)

(21) Appl. No.: 19/198,473

(22) Filed: May 5, 2025

(51) Int. Cl. G06Q 10/0631; G06Q 10/10

(52) U.S. Cl. CPC G06Q 10/06315; G06Q 10/103

(57) ABSTRACT

Various examples are directed to operating an Enterprise Resource Planning (ERP) computing system. The ERP computing system may receive first service order data describing a service item to be completed under a first service contract. The ERP computing system may determine that the first service contract data structure uses a first integration. The ERP computing system may generate a first service order data structure describing the service item, the first service order data structure using a second integration different than the first integration. The ERP computing system may settle the service order at least in part by writing a portion of the data describing the cost associated with the service item to a second service order reporting object data structure arranged according to the first integration.

### BACKGROUND

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software application. ERP applications are often used in conjunction with a DBMS to manage various aspects of business operations. An example ERP software application is the S/4 HANA product available from SAP SE of Walldorf, Germany.

### BRIEF DESCRIPTION OF DRAWINGS

The present disclosure is illustrated by way of example and not limitation in the following figures.

FIG. 1 is a diagram showing one example of an environment comprising an Enterprise Resource Planning (ERP) computing system with support for multiple integrations.

FIG. 2 is a flowchart showing one example of a process flow that may be implemented in the ERP computing system of FIG. 1 to process a service order.

FIG. 3 is a flowchart showing one example of a process flow that may be executed by the ERP system of FIG. 1 to process service order data for a service order against a service order contract having a service order contract data structure arranged to a different integration.

FIG. 4 is a diagram showing one example of an environment comprising an ERP computing system executing an ERP arrangement for multiple organizations that are part of a common enterprise.

FIG. 5 is a diagram showing one example of a workflow for the creation and lifecycle management of an inter-organization service order data structure.

FIG. 6 is a block diagram showing one example of an architecture for a computing device.

FIG. 7 is a block diagram of a machine in the example form of a computer system within which instructions may be executed for causing the machine to perform any one or more of the methodologies discussed herein.

### DETAILED DESCRIPTION

In various examples, an Enterprise Resource Planning (ERP) system executes multiple ERP applications that are integrated to one another through a database management system (DBMS). The ERP applications generate and utilizes the data stored at the DBMS to perform different enterprise operations. For example, an ERP application supporting a human resources operation may store employee records at the DBMS. The ERP application supporting human resources management may perform various tasks related to, for example, using data managed by the DBMS to generate and manage payroll, benefits, and the like. An ERP application supporting accounting may use records managed by the DBMS to perform various accounting-related tasks such as generating and recording invoices, purchase orders, and the like. Other ERP applications may perform other business tasks. An ERP application supporting operations may use records managed by the DBMS to plan various services and service items performed, for example, on behalf of enterprise customers.

Consider an example in which one or more subject ERP applications of an ERP system integrates with an accounting ERP application. Consider an example operations ERP application. The example operations ERP application may interface with the accounting ERP application to facilitate maintenance of the financial books of an enterprise as well as the creation of various data structures and tasks related to invoicing, accounts payable, and/or the like. Integration with the accounting ERP application at the DBMS may involve transferring data from one or more data structures managed by the subject ERP application to one or more accounting tables associated with the accounting ERP application.

Consider an example operations ERP application that supports service contracts. The service contract may be a contract for the performance of a service. Execution of the service contract may be implemented using one or more service orders. A service order describes service items performed under a service contract. Consider an example service contract for maintaining a set of machines. According to the example service contract, a Company A agrees to maintain a set of machines for Company B according to the terms set forth in the service contract. Service orders associated with the service contract may describe instances of maintenance performed by Company A for Company B on particular machines.

Consider another example service contract for the in-house repair of a printer or similar device. The service contract may generally cover the repair of a set of devices or equipment. Service orders may be used to describe service items under the service contract such as, for example, the repair of a particular printer. Also, consider an example service contract for the maintenance of a gas turbine used on a pipeline. In such an arrangement, the gas turbine may be part of a pump and may comprise a set of blades. The blades may need to be maintained regularly. Service orders under the service contract may describe service items under the service contract such as, for example, regular inspections of the turbine blades, repair of turbine blades exhibiting wear, replacement of unrepairable turbine blades, and/or the like.

An example ERP application may manage a service contract using a service contract data structure and one or more service order data structures. The service contract data structure may describe the service contract including, for example, terms of the service contract. Each service order data structure may describe a service order planned and/or executed under the service contract. The service order may involve one or more service items associated with the service order. A service item is a task to be performed under a service order. The service order may describe aspects of the service items such as, for example, hours of work, parts to be procured, to items, intercompany items (as described herein), and/or the like. A service item may comprise all or part of the service order. For example, a service order may comprise multiple service items.

Integrating the subject ERP application with an accounting ERP application at the DBMS may include extracting relevant revenue, cost and/or similar information from the service contract data structure and service order data structures and posting the information to one or more accounting tables accessible by the accounting ERP application. Revenue, cost, and/or the like extracted from the service contract data structure and/or service order data structures may be actual and/or deferred and may be determined using any suitable recognition technique. The posting of the extracted revenue, cost and/or similar information may prompt the accounting ERP application to perform various processing such as, for example, generating one or more purchase orders, generating one or more invoices, generating one or more accounts payable entries, and/or the like.

Data transfer between subject ERP applications and an accounting ERP application can be handled according to various integrations. Different integrations may be associated with different sets of integration actions. The integration actions associated with an integration may describe, for example, how cost, expense, and other similar data items from the subject ERP application data structures are reported to one or more DBMS tables associated with the accounting ERP application. Integration operations may be performed by the DBMS and/or by one or more ERP applications. Example integration actions may include the creation of various reporting data objects. In some examples, integration actions may also include reporting of particular data to the one or more DBMS tables associated with the accounting ERP application. In some examples, different sets of integration actions available under different integrations may be enabled by different architectural or conceptual implementation of the various integrations. Differences in architecture and/or conceptual implementation may lead to different functionalities and/or different capabilities of the ERP application.

In some examples, integration between subject ERP applications and an accounting ERP application at the DBMS is handled utilizing common reporting object integration. According to common reporting object integration, data structures generated by the subject ERP applications are integrated to the accounting ERP application via a common reporting object, such as a common cost object. For example, the subject ERP application may generate a service contract data structure and various service order data structures, as described herein. The ERP system, however, may be configured to write associated accounting data, such as cost data, to the cost data structure that is unique to the service contract. That is, for example, each service order data structure generated under the service contract may have associated accounting data integrated through a common reporting object data structure. Example integration actions under common reporting object integration may include, for example, creation and/or maintenance of the common reporting object, posting of costs, revenue, expenses, and/or the like from the common reporting object to one or more DBMS tables associated with the accounting ERP application, and/or the like.

In some examples, integration between subject ERP applications and an accounting ERP application is handled utilizing item-based integration. According to item-based integration, reporting object data structures are created at a more granular level. For example, service order data structures created under a common service contract data structure may be reported through respective reporting object data structures. In this way, a single service order data structure may have costs and other accounting items reported through multiple different reporting objects instead of just one.

Item-based integration may provide various advantages over common reporting object integration. For example, item-based integration may facilitate various integration actions that facilitate more granular reporting such as, for example, Event-Based Revenue Recognition (EBRR). According to EBRR, the accounting ERP application may be configured to more easily process costs and revenues on a service order-by-service order basis instead of at a service contract level. In some examples, EBRR are may also permit the realization of revenue and/or cost before work has been done and/or before invoices are paid. For example, EBRR may support defining revenue or cost as deferred or accrued.

Item-based integration may also enable other integration features such as, for example, a technical completion status whereby a service order data structure may be handled by the subject ERP application as being technically completed even if one or more technical operations remain or not all technicians have reported their time and/or costs completely. Also, for example, item-based integration may enable intercompany service or processing where multiple service order data structures are generated for multiple different companies under a common service contract data structure.

Item-based integration may also provide other technical advantages. For example, common reporting object data structures may be large, unwieldy, and consume considerable memory. Also, because common reporting object data structures persist for the term of the underlying-based data structure, they may be long-lived. For example, some service contracts may be open for years or even decades. Supporting a large, long-lived data structure at memory can create considerable technical challenges. For example, the large data structure may be regularly backed up to avoid data loss and/or data corruption.

The advantages of item-based integration may be achieved in a newly-implemented ERP system by creating data objects and code governing the use thereof in accordance with item-based integration at implementation. Transitioning from a common reporting object integration to an item-based integration, however, may be more challenging. For example, it may not be practical to treat existing data structures of the subject ERP application according to a different integration than what the data structures were generated to support. For example, data structures may be embedded with and/or refer to code for performing various integration actions. Accordingly, modifying an existing data structure to operate under a different integration may involve time-consuming and costly modifications to the data structures themselves. Further, because some data structures such as, for example, service contract data structures, can be quite long-lived, simply transitioning integrations for new service contracts only may significantly delay realization of the benefits of item-based integration.

Various examples described herein address these and other challenges utilizing an ERP system that is configured to support multiple integrations simultaneously. For example, an ERP system may receive a request to process a service item under a service contract. The ERP system may determine that a service contract data structure associated with the service contract uses a first integration, such as common reporting object integration. The ERP system may generate a service order data structure for the service order under an item-based integration that is different than the first integration. The service order data structure may be arranged with a pointer indicating the service contract data structure under the different integration. The ERP system may also generate a service order reporting object data structure associated with the service order data structure. The service order cost object data structure may comprise settlement data. The settlement data may include instructions and/or executable code for settling revenue, costs, and/or similar data associated with the service order data structure to the common reporting object data structure for the service contract data structure.

In this way, the ERP system may achieve some or all of the benefits of item-based integration under existing data structures generated according to a different integration. For example, new service order data structures under the first integration service contract data structure may enjoy the benefits of item-based integration actions such as, for example, use of EBRR, technical completion status, intercompany service orders, and/or the like. At the same time, it may not be necessary to update each existing service contract data structure.

This may improve incentives for transitioning existing ERP systems to achieve the technical advantages of item-based integration. It may also provide technical advantages of its own. For example, reporting object data structures generated for service order data structures may be transitory. That is, the reporting object data structures may be written to memory while being used to implement item-based integration processes, and then negated from the memory after settlement to the common reporting object at the DBMS.

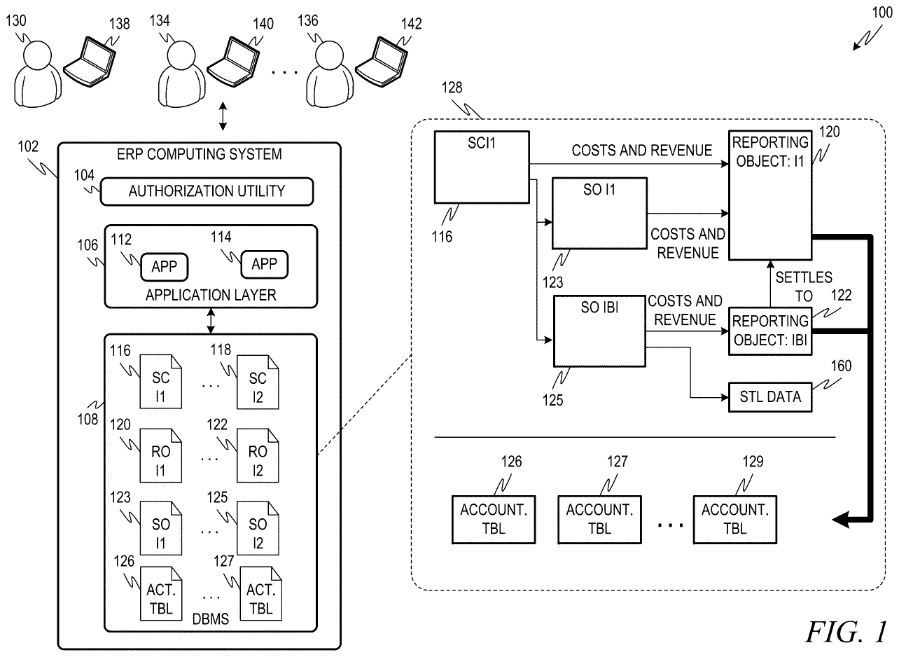

FIG. 1 is a diagram showing one example of an environment 100 comprising an ERP computing system 102 with support for multiple integrations. The environment 100 includes the ERP computing system 102 that implements a DBMS 108, an application layer 106, and an authorization utility 104. The application layer 106 comprises a set of one or more ERP application instances 112, 114. Each ERP application instance 112, 114 may execute to provide ERP functionality using the DBMS 108.

Users 130, 134, 136 may access the ERP computing system 102 to interact with the ERP application layer 106. Each user 130, 134, 136 may be associated with a user account. A user's user account may be used to determine the authorization of the user. For example, the ERP computing system 102 may implement an authorization utility 104. The authorization utility 104 may manage access of the user accounts of different users 130, 134, 136 to resources of the ERP computing system 102.

In some examples, users 130, 134, 136 may utilize user computing devices 138, 140, 142 to communicate with the ERP computing system 102. User computing devices 138, 140, 142 may be and/or include various types of computing devices such as, for example, desktop computers, laptop computers, tablet computers, mobile computing devices, and/or the like. It will be appreciated that in some on-premise applications, a user may access the ERP computing system 102 directly via input/output components of the ERP computing system 102 such as, for example, a keyboard and/or a monitor. In some examples, a user 130, 134, 136 provides credentials to the authorization utility 104 via respective user computing devices 138, 140, 142.

The ERP computing system 102 may be implemented in an on-premise environment and/or in a cloud environment. In an on-premise environment, the enterprise may maintain the ERP computing system 102 at one or more on-premise locations. In other examples, the ERP computing system 102 is implemented by one or more servers and/or other computing devices maintained by a cloud provider and accessible remotely. In a private cloud environment, the enterprise using the ERP computing system 102 may provide applications, implement storage, and/or the like to implement the DBMS 108, application layer 106, and authorization utility 104. In a public cloud environment, a cloud provider may maintain the ERP computing system 102 and provide a number of tenancies. The cloud provider may provide and maintain executables to implement the DBMS 108, application layer 106, and authorization utility 104. An enterprise may purchase a tenancy to permit users associated with that enterprise to access the ERP computing system 102 to use the DBMS 108, application layer 106, and authorization utility 104.

The DBMS 108 is illustrated with example data structures demonstrating operation of the ERP computing system 102 according to multiple integrations. Service contract data structures 116, 118 include a service contract data structure 116 arranged according to a first integration and a service order contract data structure 118 arranged according to an item-based integration that is different than the first integration. In some examples, the first integration may be a common reporting object integration. Reporting object data structures 120, 122 include a reporting object data structure 120 organized according to the first integration and a reporting object data structure 122 organized according to the item-based integration. Service order data structures 123, 125 include a service order data structure 123 arranged according to the first integration and a service order data structure 125 arranged according to the item-based integration. Reporting object data structures 120, 122 may be written with data describing various accounting at the relevant service contracts and/or service orders.

The service contract data structures 116, 118, reporting object data structures 120, 122, and service order data structures 123, 125 include one of each example arranged according to the first integration and one of each example arranged according to the item-based integration. It will be appreciated, however, that the DBMS 108 may store and support multiple examples of the various data structures arranged according to different integrations. For example, the DBMS 108 may include multiple service contract data structures according to the first integration, multiple service or contracts according to the item-based integration, multiple reporting object data structures according to the first integration, multiple reporting object data structures according to the item-based integration, and so on. Also, it will be appreciated that, in some examples, the DBMS 108 may omit some combinations of data structures and integrations.

The DBMS 108 also includes various accounting tables 126, 127. Accounting tables may be used by an accounting ERP application to store data and/or may trigger various accounting-related actions. In some examples, one or more of the accounting tables 126, 127 may be recognized cost tables storing data indicating recognized costs. Other example accounting tables 126, 127 include one or more expense tables storing data describing expenses, one or more revenue tables storing data describing revenue, and/or the like. In some examples, the DBMS 108 or other component of the ERP computing system 102 may be configured to move accounting-relevant data from one or more of the service contract data structures 116, 118 and/or service order data structures 123, 125 to one or more reporting object data structures 120, 122. The DBMS 108 and/or other component of the ERP computing system 102 may be configured to write data from the one or more reporting object data structures 120, 122 to one or more of the accounting tables 126, 127.

FIG. 1 also shows a breakout window 128 illustrating a workflow for supporting multiple integrations. In the example shown in the breakout window 128, a service contract data structure 116 uses a common reporting object integration. For example, costs and revenue from the service contract data structure 116 may be written to a reporting object data structure 120 arranged according to the first integration. For example, when the first integration is a common reporting object integration, the reporting object data structure 120 may serve as a common reporting object for the service contract data structure 116.

The breakout window 128 illustrates two service order data structures 123, 125 associated with the service contract data structure 116. The service order data structures 123, 125 may describe service orders executed under the service contract represented by the service contract data structure 116. Each service order may comprise one or more tasks to be completed in association with the service order. The service order data structure 123 uses the first integration. Accordingly, costs and revenue associated with the service order data structure 123 are written to the reporting object data structure 120. From the reporting object data structure 120, accounting data may be written to one or more accounting tables 126, 127, 129.

The service order data structure 125 may be arranged according to an item-based integration. In this example, the service order data structure 125 is associated with the service contract data structure 116 despite the service contract data structure 116 being organized according to a different integration. The service order data structure 125 may comprise a pointer referring to the service contract data structure 116 along with settlement data 160. Because the service order data structure 125 uses the item-based integration, it may report costs and revenue to a reporting object data structure 122 arranged according to the item-based integration. This may facilitate integration actions associated with item-based integration such as, for example, EBRR, implementation of a technical completion status for a service order, execution of an intercompany service order, and/or the like.

For example, EBRR may be implemented by writing cost and/or other data from the reporting object data structure 122 directly to one or more of the accounting tables 126, 127, 129. A technical completion status may be implemented, for example, by causing or canceling one or more actions associated with the service order such as, for example, a purchase order for acquiring materials or services to implement the service order, and/or the like.

The reporting object data structure 122 may be settled to the reporting object data structure 120 to facilitate a service contract indicated by the service contract data structure 116. For example, the service order data structure 125 according to the item-based integration may comprise settlement data 160. The settlement data 160 may comprise instructions, executable code, and/or other data for settling accounting data stored at the reporting object data structure 122 to the reporting object data structure 120. In some examples, the settlement data 160 includes a pointer or other indicator of the reporting object data structure 120 to which the reporting object data structure 122 is to be settled. The DBMS 108 and/or other component of the ERP computing system 102 may settle some or all of the data at the reporting object data structure 122 to the reporting object data structure 120 using some or all of the settlement data 160.

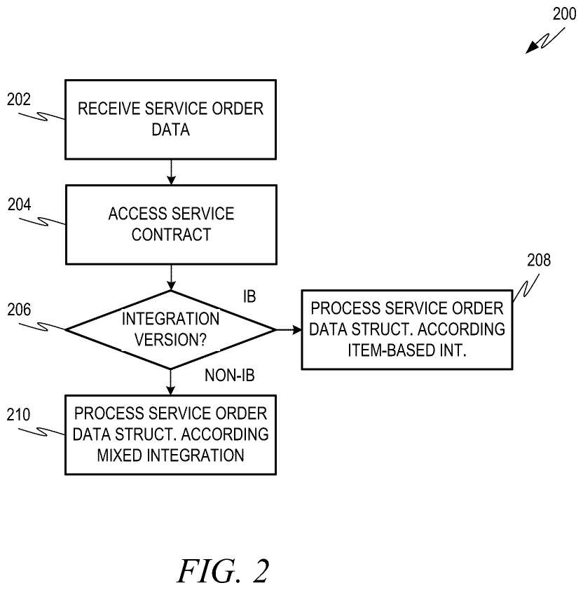

FIG. 2 is a flowchart showing one example of a process flow 200 that may be implemented in the ERP computing system 102 to process a service order. At operation 202, the ERP computing system 102 receives service order data describing a service order for execution. The service order data may be received, for example, from one or more of the users 130, 134, 136 and/or from another system or process such as, for example, by an application programming interface (API) call made by one or more of the users 130, 134, 136. The service order data may describe one or more service items to be completed for completion of the service order. In some examples, the service order data references a service contract under which the service order is to be performed. In some examples, the service order data references a service contract data structure associated with the service contract under which the service order is to be performed.

At operation 204, the ERP computing system 102 accesses the service contract data structure under which the service order described by the service order data is to be performed. At operation 206, the ERP computing system determines the integration version under which the accessed service order contract structure is organized. In some examples, the item-based integration may be implemented such that all new service order data structures generated after transition to the item-based integration are organized according to the item-based integration. Accordingly, determining whether a service order data structure is organized according to the item-based integration may comprise determining whether the service order data structure was created after transition to item-based accounting. If the service order contract data structure is organized according to the item-based integration, the ERP computing system 102 may, at operation 208, process the service order data according to the item-based integration.

This may include, for example, generating a service order data structure corresponding to the service order according to the item-based integration and generating an item-based integration reporting object to which costs and revenue associated with the service order are to be posted. It may also include performing one or more item-based integration actions against the service order data structure and/or the reporting object data structure.

If the service order contract data structure is organized according to a non-item-based integration such as, for example, a common reporting object integration, then the ERP computing system 102 may, at operation 210, process the service order data according to a mixed integration. This may include generating a service order data structure and a reporting data object according to the item-based integration. The reporting data object may be for receiving cost and revenue data from the item-based integration service order data structure. The item-based integration service order data structure may also be configured with settlement data, as described herein, describing and/or instructing how the item-based integration reporting object data structure is to be settled to a common reporting object data structure that is organized according to the non-item-based integration and associated with the service contract data structure.

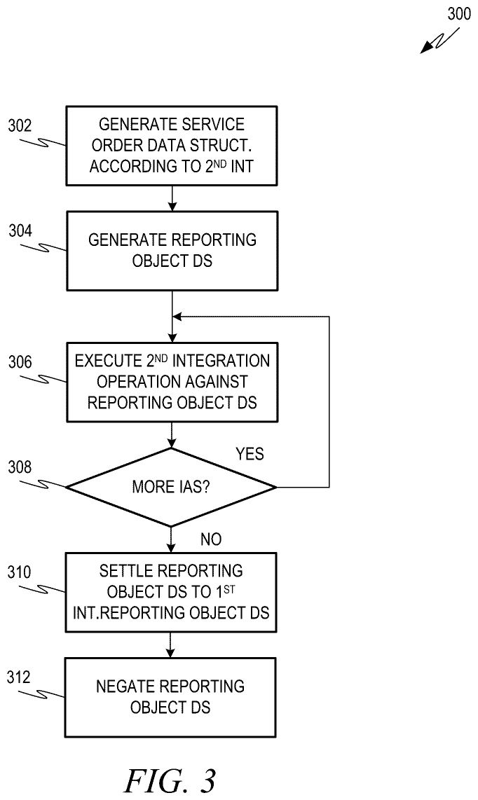

FIG. 3 is a flowchart showing one example of a process flow 300 that may be executed by the ERP system 102 to process service order data for a service order against a service order contract having a service order contract data structure arranged to a different integration. The process flow 300 shows one example way of executing the operation 210 of the process flow 200. In the example of FIG. 3, the service contract data structure uses a common reporting object integration and the service order data structure uses an item-based integration.

At operation 302, the ERP computing system 102 generates a service order data structure according to the item-based integration. At operation 304, the ERP computing system 102 generates a reporting object data structure according to the item-based integration. The service order data structure generated at operation 302 is configured to report costs and revenue data to the reporting object data structure generated at operation 304.

At operation 306, the ERP computing system 102 may execute an item-based integration action against the reporting object data structure generated at operation 304. In some examples this may include EBBR, assigning of a technical completion status to the service order, intercompany service order processing, and/or the like. Some or all of the item-based integration actions executed against the item-based integration reporting object data structure may be unsupported by the integration of the contract data structure.

At operation 308, the ERP computing system 102 determines if any additional item-based integration actions are to be executed against the service order data structure generated at operation 302. This may be based, for example, on operations requested by a user 130, 134, 136, operations requested by another system, and/or operations indicated by a suitable software workflow. If an additional item-based integration action is to be performed against the reporting object data structure, then the ERP computing system 102 may return to operation 306 and execute a next item-based integration action against the reporting object data structure.

When no more common item-based integration actions are to be executed against the reporting object data structure, the ERP computing system may, at operation 310, settle the reporting object data structure to a different reporting object data structure arranged according to the common reporting object integration. In some examples, the ERP computing system is arranged to perform the settlement automatically at the conclusion of a repeating time period such as, for example, a quarter, a week, and/or the like. For example, the ERP computing system may detect the conclusion of a repeating time period. Upon detecting the conclusion of the repeating time period, the ERP computing system may perform automatic settlement of reporting object data structures to different reporting object data structures arranged according to the common reporting object integration. In some examples, performing the settlement may include executing code and/or other instructions included in settlement data at the service order data structure.

The item-based reporting object data structure may be negated at operation 312. Negation may be performed by generating a negative posting to one or more financial tables at the DBMS. The negating of the item-based reporting object data structure may not delete the underlying data, for example, because the data was previously settled at operation 310. In this way, item-based integration actions may be executed against the service order data structure without preventing the operation of common reporting object integration actions for the service contract data structure against the common reporting object data structure.

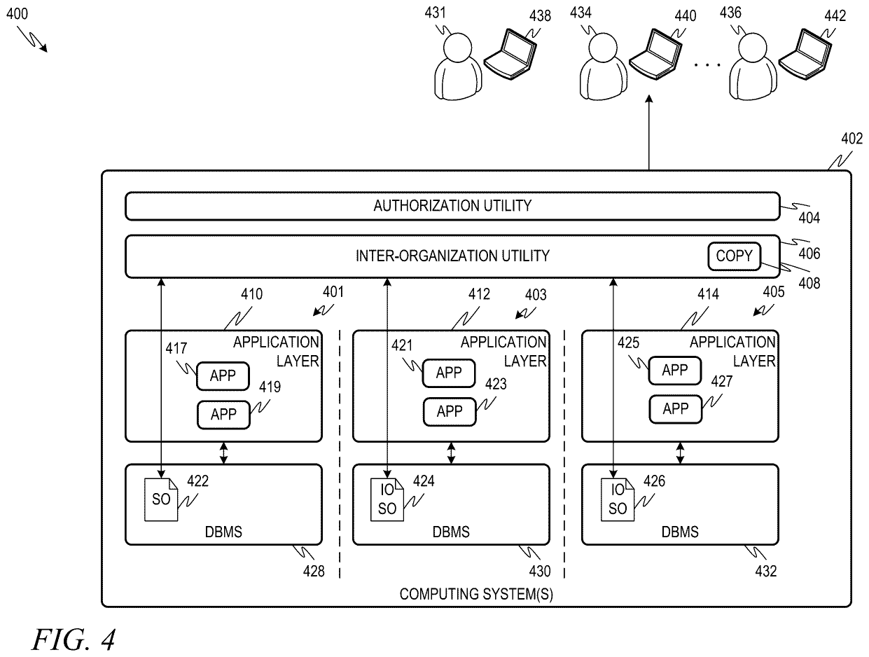

FIG. 4 is a diagram showing one example of an environment 400 comprising an ERP computing system 402 executing an ERP arrangement for multiple organizations that are part of a common enterprise. The environment 400 illustrates an example way of implementing and intercompany service order. Implementing an intercompany service order is an example of an item-based integration action that may be performed, as described herein. The environment 400 includes an ERP computing system 402 that implements DBMSs 428, 430, 432; application layers 410, 412, 414; and utilities 404, 406 for a number of organizations within a common enterprise.

In the example of FIG. 4, the ERP computing system 402 implements DBMSs 428, 430, 432 and application layers 410, 412, 414 for three different organizations 401, 403, 405 within a common enterprise. Each respective application layer 410, 412, 414 comprises a set of one or more ERP application instances 417, 419, 421, 423, 425, 427. Each ERP application instance 417, 419, 421, 423, 425, 427 may execute to manage the DBMS 428, 430, 432 of the corresponding organization 401, 403, 405 and/or perform other ERP operations.

Users 431, 434, 436 may access the ERP computing system 402 to interact with the ERP application layers 410, 412, 414. Each user 431, 434, 436 may be associated with a user account. A user's user account may be used to determine the authorization of the user. For example, the ERP computing system 402 may implement an authorization utility 404. The authorization utility 404 may manage access of the user accounts of different users 431, 434, 436 to resources of the different organizations 401, 403, 405.

In some examples, users 431, 434, 436 may utilize user computing devices 438, 440, 442 to communicate with the ERP computing system 402. In some examples, a user 431, 434, 436 provides credentials to the authorization utility 404 via respective user computing devices 438, 440, 442. Based on the credentials, the authorization utility 404 may authorize a user account to perform various different operations at one or more of the respective organizations 401, 403, 405.

The ERP computing system 402 may be implemented in an on-premise environment and/or in a cloud environment. In an on-premise environment, the enterprise including the organizations 401, 403, 405 may maintain the ERP computing system 402 at one or more on-premise locations. In some examples, the DBMSs 428, 430, 432 are maintained as separate instances of a common DBMS application and/or storage. In other examples, the DBMSs 428, 430, 432 may be maintained as different partitions of a common DBMS instance. Also, the ERP application instances 417, 419, 421, 423, 425, 427 may be executed as separate instances of common ERP applications and/or may be common instances of ERP applications instance 417, 419, 421, 423, 425, 427 configured to separately support different organizations 401, 403, 405.

In other examples, the ERP computing system 402 is implemented by one or more servers and/or other computing devices maintained by a cloud provider and accessible remotely. In a private cloud environment, the enterprise using the ERP computing system 402 may provide applications, implement storage, and/or the like to implement the DBMSs 428, 430, 432; application layers 410, 412, 414; and utilities 404, 406. In a public cloud environment, a cloud provider may maintain the ERP computing system 402 and provide a number of tenancies. The cloud provider may provide and maintain executables to implement the DBMSs 428, 430, 432; application layers 410, 412, 414; and utilities 404, 406. An enterprise may purchase a tenancy to permit users associated with that enterprise to access the ERP computing system 402 to use the DBMSs 428, 430, 432; application layers 410, 412, 414; and utilities 404, 406. In some examples, data segregation may be achieved by separating the components associated with different organizations 401, 403, 405 into separate tenancies. The utilities 404, 408 may execute across tenancies, for example, with access to the DBMSs 428, 430, 432 and/or communication to the application instances 417, 419, 421, 423, 425, 427 across organizations 401, 403, 405.

FIG. 4 shows a source service order data structure 422 created at the DBMS 428 of the organization 401. For example, the source service order data structure 422 is generated by an ERP application instance 417, 419 of the organization 401 in response to a request from a user account having authorization privileges at the organization 401. The source service order data structure 422 may be arranged according to a first integration to support a service contract data structure arranged according to a second integration. For example, the source service order data structure 422 may be arranged according to an item-based integration to support a service contract data structure arranged according to a common reporting object integration, as described herein.

For example, a user 431, 434, 436 may provide authentication data to the authorization utility 404 to access the privileges of a corresponding user account. The user account generating the source service order data structure 422 may lack authorization privileges at elements of the other organizations 403, 405. For example, the user account generating the source service order data structure 422 may request to view or otherwise access one or more of the inter-organization service order data structures 424, 426. The authorization utility 404 or other suitable component may be configured to deny the user's request unless the user possesses separate privileges for accessing the respective DBMSs 430, 432.

The source service order data structure 422 may comprise an identifier of the organization 401 and service item data describing at least one service item to be performed, for example, on behalf of a customer of the enterprise. The inter-organization utility 406 may be an ERP application that is configured to distribute a service item or service item component from the source service order data structure 422 to one or more of the organizations 403, 405. In this example, the inter-organization utility 406 is configured to generate a first inter-organization service order data structure 424 including service item data describing at least one service item from the source service order data structure 422 at the DBMS 430 of the organization 403 and a second inter-organization service order data structure 426 including service item data describing at least one of the service items from the source service order data structure 422 at the DBMS 432 of the organization 405. In some examples, the inter-organization utility utilizes a copy utility 408 to generate the respective inter-organization service order data structures 424, 426, as described herein.

In some examples, the second inter-organization service order data structure 426 may be generated from the source service order data structure 422. Also, in some examples, the second inter-organization service order data structure 426 may be generated from the inter-organization service order data structure 424. In this way, the inter-organization service order data structure 424 may act as a source service order data structure with respect to the second inter-organization data structure 426. In this example, the various arrangements described herein for processing source and inter-organization service order data structures may be applied with respect to the first inter-organization service order data structure 424 and the second inter-organization service order data structure 426, with the inter-organization service order data structure 424 being treated as a source service order data structure.

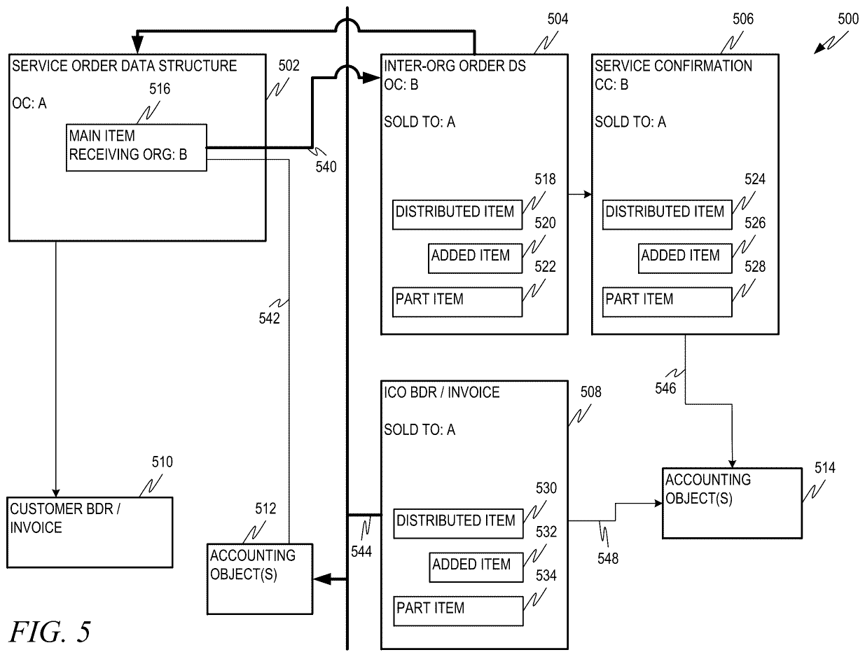

FIG. 5 is a diagram showing one example of a workflow 500 for the creation and lifecycle management of an inter-organization service order data structure. In various examples, the workflow 500 may be performed in the environment 400 of FIG. 4. Initially, the source service order data structures 502 may be generated, for example, at a DBMS of a source organization. The source service order data structure 502 may be generated, for example, based on a request from a user account associated with the source organization.

The source service order data structure 502 may comprise an indicator of the source organization, in this example the letter “A,” and item data indicating a main service item 516. In some examples, the main service item 516 includes data indicating that the main service item 516 is to be distributed to another organization. Also, in some examples, the main service item 516 may include data indicating an identity of the organization to which the main service item 516 is to be distributed. In this example, the receiving organization is indicated by “B.”

When the inter-organization service order data structure 502 is complete, an inter-organization service order data structure 504 may, at operation 540, be generated at a DBMS associated with the receiving organization. In addition, an accounting object 512 may be generated at operation 542. The accounting object 512 may indicate an account payable posting that will be made to the DBMS of the source organization, for example, upon completion of the main service item 516. The inter-organization service order data structure 502, in some examples, may be visible to user accounts associated with the source organization.

The inter-organization service order data structure 504 may indicate an organization code or other identifier of the receiving organization B. It may also indicate that the organization A is the “sold to” party for the service order. The intercompany service order data structure 504 may include item data describing a distributed service item 518, which may be equivalent to the main service item 516. In this example, the inter-organization service order data structure 504 also includes data items describing an added item 520 and a part item 522. The added item 520 may be an item associated with the main service item 516 that was added, for example, by a user account associated with the receiving organization. This may reflect, for example, a service that is subsidiary to but part of the main distributed service item 518. The part item 522 may describe a part that is or was used to perform the main service item 516/distributed service item 518.

A service confirmation data structure 506 may be generated for example, upon receiving confirmation that the distributed service item 518 has been completed. The service confirmation data structure 506 may be similar to the inter-organization service order data structure 504 and may indicate the receiving organization B, the source organization A, and the service items that were completed, in this case, an indication of a distributed service item 524 corresponding to the distributed service item 518 and the main service item 516, and added service item 526 corresponding to the added item 520, and a part item 528 corresponding to the part item 522.

The creation of the service confirmation data structure 506 may trigger a release of the inter-organization service order data structure 504 billing. This may prompt the inter-organization utility 406 and/or an appropriate ERP instance 417, 419, 421, 423, 425, 427 to generate an invoice data structure 508 at operation 544. The invoice data structure 508 may be similar to the inter-organizational service order data structure 504 and may indicate the receiving organization B, the source organization A, and the service items that were completed, in this case, an indication of a distributed service item 530 corresponding to the distributed service item 518 and the main service item 516, an added service item 532 corresponding to the added item 520, and a part item 534 corresponding to the part item 522.

The invoice data structure 508 may prompt the creation of an accounting object 514 from the invoice data structure 508 (path 548) and the service confirmation data structure 506 (path 546). The accounting object 514 may be generated to record costs to the receiving organization associated with completion of the items 524, 526, 528 as well as revenue received or to be received via an accounts payable generated at accounting object 512. In addition, a customer invoice data structure 510 may be generated. The customer invoice data structure 510 may prompt the provision of an invoice to the customer of the source service order data structure 502.

In view of the disclosure above, various examples are set forth below. It should be noted that one or more features of an example, taken in isolation or combination, should be considered within the disclosure of this application.

### EXAMPLES

Example 1 is an enterprise resource planning (ERP) computing system comprising: at least one hardware processor programmed to perform operations comprising: receiving, from a first user, first service order data describing a service item to be completed under a first service contract, the first service order data describing a first service contract data structure stored at a database management system executed at the ERP computing system; determining that the first service contract data structure uses a first integration with at least one accounting table stored by the database management system; generating a first service order data structure describing the service item, the first service order data structure comprising a pointer to the first service contract data structure, the first service order data structure using a second integration with at least one accounting table that is different than the first integration; generating a first service order reporting object data structure using the second integration, the first service order reporting object data structure comprising data describing a cost associated with the service item; based at least in part on the determining that the service contract data structure uses the first integration, associating settlement data to the first service order reporting object data structure; and settling a service order associated with the service order data structure based at least in part on the settlement data, the settling of the service item comprising writing at least a portion of the data describing the cost associated with the service item to a second service order reporting object data structure, the second service order reporting object data structure using the first integration.

In Example 2, the subject matter of Example 1 optionally includes the settling of the service order associated with the service order data structure being performed automatically upon detection by the ERP computing system of a conclusion of a time period.

In Example 3, the subject matter of any one or more of Examples 1-2 optionally include the operations further comprising executing an integration action against the first service order reporting object data structure, the integration action being supported by the second integration and being unsupported by the first integration.

In Example 4, the subject matter of Example 3 optionally includes the integration action comprising writing at least a portion of the data describing the cost associated with the service item to a recognized cost table of the database management system.

In Example 5, the subject matter of Example 4 optionally includes the integration action comprising: writing to a cost table of the database management system an indication that the service item is technically completed; and deleting at least one purchase order data structure describing a purchase associated with the service item.

In Example 6, the subject matter of any one or more of Examples 1-5 optionally include the first integration being associated with a first plurality of integration actions for integrating with the at least one accounting table and the second integration being associated with a second plurality of integration actions for integrating with the at least one accounting table, the operations further comprising executing an integration action selected from the second plurality of integration actions against the second service order reporting object data structure.

In Example 7, the subject matter of any one or more of Examples 1-6 optionally include the operations further comprising: receiving, from the first user, second service order data describing a second service item to be completed under a second service contract, the second service order data describing a second service contract data structure stored at the database management system; determining that the second service contract data structure uses the second integration; and generating a second service order data structure describing the second service item, the second service order data structure comprising a pointer to the second service contract data structure, the second service order data structure using the second integration.

In Example 8, the subject matter of any one or more of Examples 1-7 optionally include the settlement data comprising pointer data describing the second service order reporting object data structure.

In Example 9, the subject matter of any one or more of Examples 1-8 optionally include the first service order data describing a source service order to be completed by a first organization, the first service order data structure comprising an identifier of the first organization, and service item data describing at least one service item to be performed to complete the service item, the operations further comprising: accessing distribution request data, the distribution request data describing a request from a first user account that a first service item of the at least one service item be distributed for completion by a second organization, the first user account being associated with authorization privileges to access the database management system; generating a first inter-organization service order data structure describing a first inter-organization service order to be completed by the second organization, the first inter-organization service order data structure comprising an identifier of the second organization, inter-organization indicator data, and service item data describing the service item; and storing the first inter-organization service order data structure to a second database management system, the first user account lacking authorization privileges to access the second database management system.

Example 10 is a method for enterprise resource management using a database management system, the method comprising: receiving, from a first user, first service order data describing a service item to be completed under a first service contract, the first service order data describing a first service contract data structure stored at a database management system executed at an ERP computing system; determining that the first service contract data structure uses a first integration with at least one accounting table stored by a database management system; generating a first service order data structure describing the service item, the first service order data structure comprising a pointer to the first service contract data structure, the first service order data structure using a second integration with at least one accounting table that is different than the first integration; generating a first service order reporting object data structure using the second integration, the first service order reporting object data structure comprising data describing a cost associated with the service item; based at least in part on the determining that the service contract data structure uses the first integration, associating settlement data to the first service order reporting object data structure; and settling a service order associated with the service order data structure based at least in part on the settlement data, the settling of the service item comprising writing at least a portion of the data describing the cost associated with the service item to a second service order reporting object data structure, the second service order reporting object data structure using the first integration.

In Example 11, the subject matter of Example 10 optionally includes the settling of the service order associated with the service order data structure being performed automatically upon detection by the ERP computing system of a conclusion of a time period.

In Example 12, the subject matter of any one or more of Examples 10-11 optionally include executing an integration action against the first service order reporting object data structure, the integration action being supported by the second integration and being unsupported by the first integration.

In Example 13, the subject matter of Example 12 optionally includes the integration action comprising writing at least a portion of the data describing the cost associated with the service item to a recognized cost table of the database management system.

In Example 14, the subject matter of any one or more of Examples 12-13 optionally include the integration action comprising: writing to a cost table of the database management system an indication that the service item is technically completed; and deleting at least one purchase order data structure describing a purchase associated with the service item.

In Example 15, the subject matter of any one or more of Examples 10-14 optionally include the first integration being associated with a first plurality of integration actions for integrating with the at least one accounting table and the second integration being associated with a second plurality of integration actions for integrating with the at least one accounting table, further comprising executing an integration action selected from the second plurality of integration actions against the second service order reporting object data structure.

In Example 16, the subject matter of any one or more of Examples 10-15 optionally include receiving, from the first user, second service order data describing a second service item to be completed under a second service contract, the second service order data describing a second service contract data structure stored at the database management system; determining that the second service contract data structure uses the second integration; and generating a second service order data structure describing the second service item, the second service order data structure comprising a pointer to the second service contract data structure, the second service order data structure using the second integration.

In Example 17, the subject matter of any one or more of Examples 10-16 optionally include the settlement data comprising pointer data describing the second service order reporting object data structure.

In Example 18, the subject matter of any one or more of Examples 10-17 optionally include the first service order data describing a source service order to be completed by a first organization, the first service order data structure comprising an identifier of the first organization, and service item data describing at least one service item to be performed to complete the service item, the method further comprising: accessing distribution request data, the distribution request data describing a request from a first user account that a first service item of the at least one service item be distributed for completion by a second organization, the first user account being associated with authorization privileges to access the database management system; generating a first inter-organization service order data structure describing a first inter-organization service order to be completed by the second organization, the first inter-organization service order data structure comprising an identifier of the second organization, inter-organization indicator data, and service item data describing the first service item; and storing the first inter-organization service order data structure to a second database management system, the first user account lacking authorization privileges to access the second database management system.

Example 19 is a non-transitory machine-readable medium comprising instructions thereon that, when executed by at least one processor, cause the at least one processor to perform operations comprising: receiving, from a first user, first service order data describing a service item to be completed under a first service contract, the first service order data describing a first service contract data structure stored at a database management system executed at an ERP computing system; determining that the first service contract data structure uses a first integration with at least one accounting table stored by a database management system; generating a first service order data structure describing the service item, the first service order data structure comprising a pointer to the first service contract data structure, the first service order data structure using a second integration with at least one accounting table that is different than the first integration; generating a first service order reporting object data structure using the second integration, the first service order reporting object data structure comprising data describing a cost associated with the service item; based at least in part on the determining that the service contract data structure uses the first integration, associating settlement data to the first service order reporting object data structure; and settling a service order associated with the service order data structure based at least in part on the settlement data, the settling of the service item comprising writing at least a portion of the data describing the cost associated with the service item to a second service order reporting object data structure, the second service order reporting object data structure using the first integration.

In Example 20, the subject matter of Example 19 optionally includes the settling of the service order associated with the service order data structure being performed automatically upon detection by the ERP computing system of a conclusion of a time period.

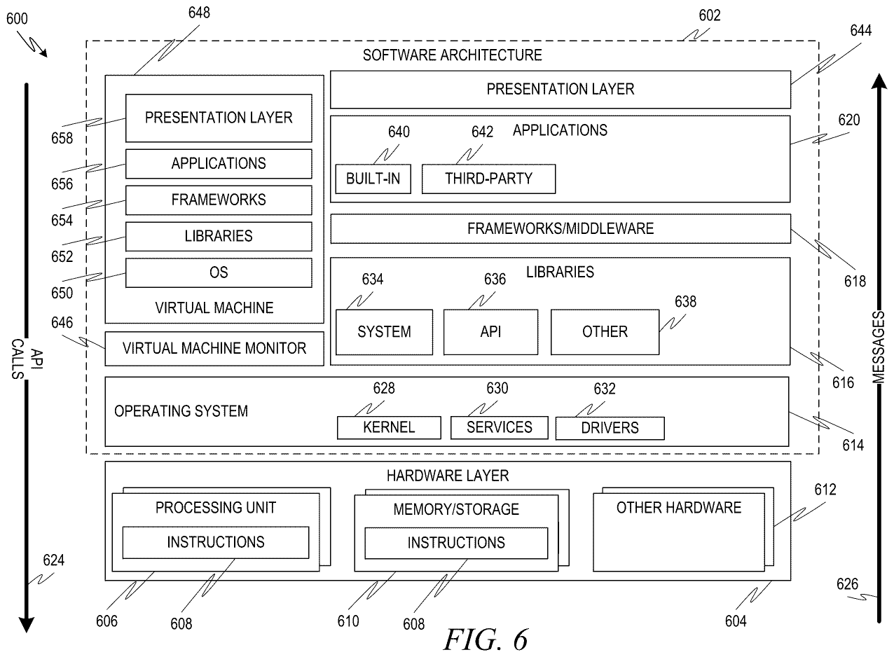

FIG. 6 is a block diagram 600 showing one example of a software architecture 602 for a computing device. The software architecture 602 may be used in conjunction with various hardware architectures, for example, as described herein. FIG. 6 is merely a non-limiting example of a software architecture and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 6.

The representative hardware layer 604 comprises one or more processing units 606 having associated executable instructions 608. Executable instructions 608 represent the executable instructions of the software architecture 602, including implementation of the methods, modules, subsystems, and components, and so forth described herein and may also include memory and/or storage modules 610, which also have executable instructions 608. Hardware layer 604 may also comprise other hardware as indicated by other hardware 612, which represents any other hardware of the hardware layer 604, such as the other hardware illustrated as part of the architecture 602.

In the example architecture of FIG. 6, the software architecture 602 may be conceptualized as a stack of layers where each layer provides particular functionality. For example, the software architecture 602 may include layers such as an operating system 614, libraries 616, middleware layer 618, applications 620, and presentation layer 644. Operationally, the applications 620 and/or other components within the layers may invoke API calls 624 through the software stack and access a response, returned values, and so forth illustrated as messages 626 in response to the API calls 624. The layers illustrated are representative in nature and not all software architectures have all layers. For example, some mobile and/or special purpose operating systems may not provide a middleware layer 618, while others may provide such a layer. Other software architectures may include additional and/or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the architecture 602 to pause its current processing and execute an interrupt service routine (ISR) when an interrupt is accessed.

The drivers 632 may be responsible for controlling and/or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be utilized by the applications 620 and/or other software components/modules. For example, the middleware layer 618 may provide various graphic user interface (GUI) functions, high-level resource management, high-level location services, and so forth. The middleware layer 618 may provide a broad spectrum of other APIs that may be utilized by the applications 620 and/or other software components/modules, some of which may be specific to a particular operating system and/or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built-in operating system functions (e.g., kernel 628, services 630 and/or drivers 632), libraries (e.g., system 634, API libraries 636, and other libraries 638), and middleware layer 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by a virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine 648 as well as the interface with the host operating system (i.e., operating system 614). A software architecture executes within the virtual machine 648 such as an operating system 650, libraries 652, frameworks/middleware 654, applications 656 and/or presentation layer 658. These layers of software architecture executing within the virtual machine 648 can be the same as corresponding layers previously described or may be different.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### ELECTRONIC APPARATUS AND SYSTEM

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

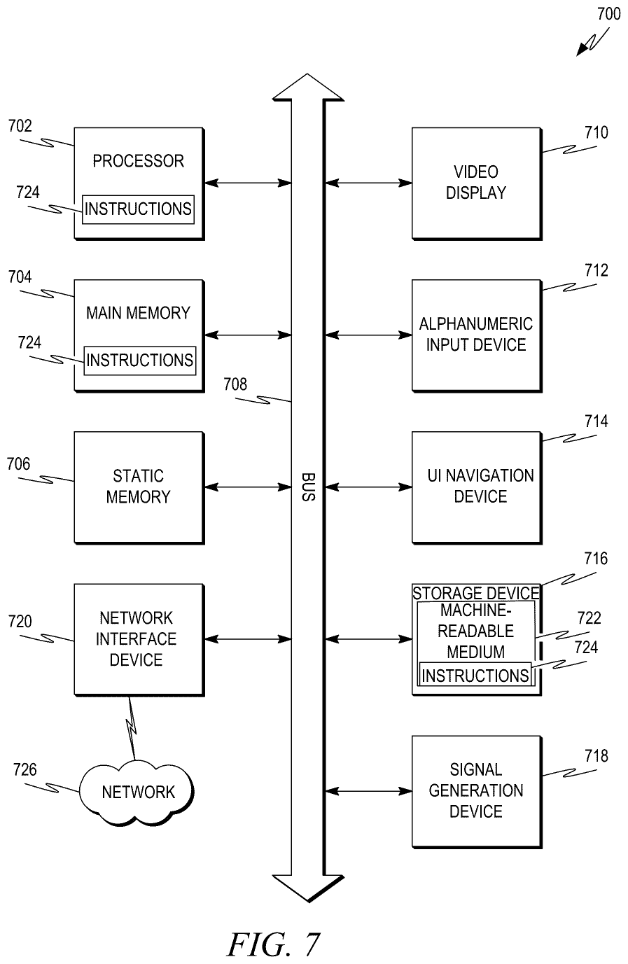

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface navigation (or cursor control) device 714 (e.g., a mouse), a disk drive unit 716, a signal generation device 718 (e.g., a speaker), and a network interface device 720.

### MACHINE-READABLE MEDIUM

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### TRANSMISSION MEDIUM

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An enterprise resource planning (ERP) computing system comprising:
at least one hardware processor programmed to perform operations comprising:
receiving, from a first user, first service order data describing a service item to be completed under a first service contract, the first service order data describing a first service contract data structure stored at a database management system executed at the ERP computing system;
determining that the first service contract data structure uses a first integration with at least one accounting table stored by the database management system;
generating a first service order data structure describing the service item, the first service order data structure comprising a pointer to the first service contract data structure, the first service order data structure using a second integration with at least one accounting table that is different than the first integration;
generating a first service order reporting object data structure using the second integration, the first service order reporting object data structure comprising data describing a cost associated with the service item;
based at least in part on the determining that the service contract data structure uses the first integration, associating settlement data to the first service order reporting object data structure; and
settling a service order associated with the service order data structure based at least in part on the settlement data, the settling of the service item comprising writing at least a portion of the data describing the cost associated with the service item to a second service order reporting object data structure, the second service order reporting object data structure using the first integration.

2. The ERP computing system of claim 1, the settling of the service order associated with the service order data structure being performed automatically upon detection by the ERP computing system of a conclusion of a time period.

3. The ERP computing system of claim 1, the operations further comprising executing an integration action against the first service order reporting object data structure, the integration action being supported by the second integration and being unsupported by the first integration.

4. The ERP computing system of claim 3, the integration action comprising writing at least a portion of the data describing the cost associated with the service item to a recognized cost table of the database management system.

5. The ERP computing system of claim 4, the integration action comprising:
writing to a cost table of the database management system an indication that the service item is technically completed; and
deleting at least one purchase order data structure describing a purchase associated with the service item.

6. The ERP computing system of claim 1, the first integration being associated with a first plurality of integration actions for integrating with the at least one accounting table and the second integration being associated with a second plurality of integration actions for integrating with the at least one accounting table, the operations further comprising executing an integration action selected from the second plurality of integration actions against the second service order reporting object data structure.

7. The ERP computing system of claim 1, the operations further comprising:
receiving, from the first user, second service order data describing a second service item to be completed under a second service contract, the second service order data describing a second service contract data structure stored at the database management system;
determining that the second service contract data structure uses the second integration; and
generating a second service order data structure describing the second service item, the second service order data structure comprising a pointer to the second service contract data structure, the second service order data structure using the second integration.

8. The ERP computing system of claim 1, the settlement data comprising pointer data describing the second service order reporting object data structure.

9. The ERP computing system of claim 1, the first service order data describing a source service order to be completed by a first organization, the first service order data structure comprising an identifier of the first organization, and service item data describing at least one service item to be performed to complete the service item, the operations further comprising:
accessing distribution request data, the distribution request data describing a request from a first user account that a first service item of the at least one service item be distributed for completion by a second organization, the first user account being associated with authorization privileges to access the database management system;
generating a first inter-organization service order data structure describing a first inter-organization service order to be completed by the second organization, the first inter-organization service order data structure comprising an identifier of the second organization, inter-organization indicator data, and service item data describing the service item; and
storing the first inter-organization service order data structure to a second database management system, the first user account lacking authorization privileges to access the second database management system.

10. A method for enterprise resource management using a database management system, the method comprising:
receiving, from a first user, first service order data describing a service item to be completed under a first service contract, the first service order data describing a first service contract data structure stored at a database management system executed at an ERP computing system;
determining that the first service contract data structure uses a first integration with at least one accounting table stored by a database management system;
generating a first service order data structure describing the service item, the first service order data structure comprising a pointer to the first service contract data structure, the first service order data structure using a second integration with at least one accounting table that is different than the first integration;
generating a first service order reporting object data structure using the second integration, the first service order reporting object data structure comprising data describing a cost associated with the service item;
based at least in part on the determining that the service contract data structure uses the first integration, associating settlement data to the first service order reporting object data structure; and
settling a service order associated with the service order data structure based at least in part on the settlement data, the settling of the service item comprising writing at least a portion of the data describing the cost associated with the service item to a second service order reporting object data structure, the second service order reporting object data structure using the first integration.

11. The method of claim 10, the settling of the service order associated with the service order data structure being performed automatically upon detection by the ERP computing system of a conclusion of a time period.

12. The method of claim 10, further comprising executing an integration action against the first service order reporting object data structure, the integration action being supported by the second integration and being unsupported by the first integration.

13. The method of claim 12, the integration action comprising writing at least a portion of the data describing the cost associated with the service item to a recognized cost table of the database management system.

14. The method of claim 12, the integration action comprising:
writing to a cost table of the database management system an indication that the service item is technically completed; and
deleting at least one purchase order data structure describing a purchase associated with the service item.

15. The method of claim 10, the first integration being associated with a first plurality of integration actions for integrating with the at least one accounting table and the second integration being associated with a second plurality of integration actions for integrating with the at least one accounting table, further comprising executing an integration action selected from the second plurality of integration actions against the second service order reporting object data structure.

16. The method of claim 10, further comprising:
receiving, from the first user, second service order data describing a second service item to be completed under a second service contract, the second service order data describing a second service contract data structure stored at the database management system;
determining that the second service contract data structure uses the second integration; and
generating a second service order data structure describing the second service item, the second service order data structure comprising a pointer to the second service contract data structure, the second service order data structure using the second integration.

17. The method of claim 10, the settlement data comprising pointer data describing the second service order reporting object data structure.

18. The method of claim 10, the first service order data describing a source service order to be completed by a first organization, the first service order data structure comprising an identifier of the first organization, and service item data describing at least one service item to be performed to complete the service item, the method further comprising:
accessing distribution request data, the distribution request data describing a request from a first user account that a first service item of the at least one service item be distributed for completion by a second organization, the first user account being associated with authorization privileges to access the database management system;
generating a first inter-organization service order data structure describing a first inter-organization service order to be completed by the second organization, the first inter-organization service order data structure comprising an identifier of the second organization, inter-organization indicator data, and service item data describing the first service item; and
storing the first inter-organization service order data structure to a second database management system, the first user account lacking authorization privileges to access the second database management system.

19. A non-transitory machine-readable medium comprising instructions thereon that, when executed by at least one processor, cause the at least one processor to perform operations comprising:
receiving, from a first user, first service order data describing a service item to be completed under a first service contract, the first service order data describing a first service contract data structure stored at a database management system executed at an ERP computing system;
determining that the first service contract data structure uses a first integration with at least one accounting table stored by a database management system;
generating a first service order data structure describing the service item, the first service order data structure comprising a pointer to the first service contract data structure, the first service order data structure using a second integration with at least one accounting table that is different than the first integration;
generating a first service order reporting object data structure using the second integration, the first service order reporting object data structure comprising data describing a cost associated with the service item;
based at least in part on the determining that the service contract data structure uses the first integration, associating settlement data to the first service order reporting object data structure; and
settling a service order associated with the service order data structure based at least in part on the settlement data, the settling of the service item comprising writing at least a portion of the data describing the cost associated with the service item to a second service order reporting object data structure, the second service order reporting object data structure using the first integration.

20. The non-transitory machine-readable medium of claim 19, the settling of the service order associated with the service order data structure being performed automatically upon detection by the ERP computing system of a conclusion of a time period.
